(19) United States
(12) Patent Application Publication
(10) Pub. No.: US 2009/0286103 A1
(43) Pub. Date: Nov. 19, 2009

(54) COATED ARTICLES AND RELATED METHODS

(75) Inventors: Glenn Sklar, Reno, NV (US); Alan Lai, Westborough, MA (US); Alan C. Lund, Framingham, MA (US)

Correspondence Address: WOLF GREENFIELD & SACKS, P.C., 600 ATLANTIC AVENUE, BOSTON, MA, 02210-2206, US

(73) Assignee: Xtalic Corporation, Marlborough, MA (US)

(21) Appl. No.: 12/120,564

(22) Filed: May 14, 2008

(51) Int. Cl. B32B 15/01

(52) U.S. Cl. 428/615

(57) ABSTRACT

Coated articles and related methods are described. In some cases, the coated articles may exhibit high strength, hardness, brightness, abrasion resistance, corrosion resistance, and other desirable structural and functional properties. In some embodiments, the coatings may include an alloy, such as a nickel-tungsten alloy and/or metal oxides.

### FIELD OF INVENTION

The present invention relates generally to coated articles and related methods and, more particularly, to metal coated articles produced using electrodeposition processes.

### BACKGROUND OF INVENTION

Coatings are often used to impart a unique functionality to the surface of an article. For example, metallic coatings deposited from electroless or electrolytic baths are often applied to articles in order to provide them with one or more improved surface properties, including hardness, abrasion resistance, luster, reflectivity, color or other visual appearance, wear resistance, and lubricity, amongst others. Such coatings are also frequently provided on a material surface in order to improve corrosion resistance. This is generally required if the article will be exposed to, either in processing, storage, or use, an environment that might promote corrosive processes at one or more surfaces that are exposed to that environment. A common example in this regard is a surface that may contact a liquid medium, including aqueous solutions, acidic or basic solutions, or alcohol-based solutions. Although corrosion is typically a problem when the environment includes a fluid, corrosion also occurs quite commonly in vapor environments.

Corrosion processes, in general, can affect the structure and composition of a surface of an article that is exposed to the corrosive environment. For example, corrosion can involve direct dissolution of atoms from the surface of the article, a change in surface chemistry of the article through selective dissolution or de-alloying, or a change in surface chemistry and structure of the article through, e.g., oxidation or the formation of a passive film. Some of these processes may change the topography, texture, properties or appearance of the article surface. For example, the process of rust formation can affect the appearance and properties of iron or steel surfaces. Metallic articles are often subjected to corrosive environments.

Coatings on such articles can affect surface corrosion in several ways. In many cases, the coating may form a barrier to protect the underlying substrate from corrosion and/or to prevent the underlying substrate from coming into direct contact with the corrosive medium. For example, a coherent coating may completely cover a substrate, leaving essentially no portion of the substrate exposed to the corrosive environment, wherein the coating acts as a protective barrier. Thus, it may be desirable for a barrier coating to exhibit higher corrosion resistance (i.e., a lower corrosion rate) for a corrosive environment than the substrate, to reduce the total corrosion rate of the article. However, defects in a barrier coating such as cracks, voids, or pore channels penetrating the coating, can expose the substrate to the corrosive environment. This may lead to a process of “localized corrosion,” which is generally undesirable.

Another common coating function is to provide an article surface that is generally non-reactive in (e.g., inert to) a target environment; or, to provide an outermost surface which generally does not undergo localized chemical reactions that may change the surface properties of the article. For example, a coating which discolors, tarnishes, dissolves, or otherwise degrades in a corrosive medium may be undesirable, especially when the coating is applied at least in part for aesthetic purposes. A process of passivation is sometimes applied to achieve a less reactive or more “passive” surface that can resist chemical attack, degradation, discoloration, or tarnishing.

Tungsten-based coatings are commonly produced by electrodeposition techniques. For example, such coatings may be tungsten alloys including one or more of the elements Ni, Fe, Co, B, S and P. These coatings often exhibit desirable properties, including high hardness, abrasion resistance, good luster, wear properties, coefficient of friction in sliding applications, etc. While tungsten-based coatings may provide reasonable substrate protection, the outer surface of the coating is often prone to chemical corrosion, degradation, discoloration, or tarnishing when exposed to corrosive media. Thus, there is a need for improvements to tungsten-based coatings which render their surfaces chemically more inert in corrosive environments, and prevent discoloration, tarnishing or degradation.

### SUMMARY OF INVENTION

The present invention generally relates to coated articles and related methods.

In one aspect, an article is provided. The article comprises a substrate and a coating formed on the substrate. The coating has a first portion and a second portion. The second portion comprises nickel, tungsten and oxygen. The weight percentage of tungsten in the second portion is between 1 and 20 percent.

In another aspect, an article is provided. The article comprises a substrate and a coating formed on the substrate. The coating comprises nickel and tungsten. The article has a CASS corrosion lifetime of at least 2 hours.

In another aspect, a method for electrodepositing a coating is provided. The method comprises providing an anode, a cathode, an electrodeposition bath associated with the anode and the cathode, and a power supply connected to the anode and the cathode. The method further comprises driving the power supply to generate a waveform to electrodeposit a coating. The waveform includes a segment comprising at least one forward pulse and at least one reverse pulse. The at least one forward pulse has a duration and an average forward current density, and the at least one reverse pulse has a duration and an average reverse current density. The ratio of the average forward current density integrated over the duration of the forward pulse to the average reverse pulse integrated over the duration of the reverse pulse is between 0.5 and 5.

In another aspect, a method for electrodepositing a coating is provided. The method comprises providing an anode, a cathode, an electrodeposition bath associated with the anode and the cathode, and a power supply connected to the anode and the cathode. The method further comprises driving the power supply to generate a waveform to electrodeposit a coating. The waveform includes a segment comprising at least one forward pulse and at least one reverse pulse. The at least one forward pulse has a duration between about 1 and about 100 ms, with an average forward current density of between about 0.01 and 1 A/cm². The at least one reverse pulse has a duration between about 1 and about 100 ms, with an average reverse current density of between about 0.01 and 1 A/cm².

In another aspect, a method of forming a coated article is provided. The method comprises providing an anode, a cathode, an electrodeposition bath associated with the anode and the cathode, and a power supply connected to the anode and the cathode, wherein the electrochemical bath comprises nickel species and tungsten species. The method further comprises driving the power supply to generate a waveform to electrodeposit a coating on a substrate to form a coated article. The coating comprises nickel and tungsten. The article has a CASS corrosion lifetime of at least 2 hours.

In another aspect, a method of forming a coated article is provided. The method comprises providing an anode, a cathode, an electrodeposition bath associated with the anode and the cathode, and a power supply connected to the anode and the cathode, wherein the electrochemical bath comprises nickel species and tungsten species. The method further comprises driving the power supply to generate a waveform to electrodeposit a coating on a substrate to form a coated article, the coating having a first portion and a second portion. The second portion comprises nickel, tungsten and oxygen, wherein the weight percentage of tungsten in the second portion is between 1 and 20 percent.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

FIG. 1 shows a schematic diagram of a coated article, according to one embodiment of the invention.

FIG. 2 shows a copy of a photograph of panel specimens coated with Ni—W alloys using (a) a two-step, reverse-pulse electrodeposition process and (b) a one-step, reverse-pulse electrodeposition process, after 14 hours of standard CASS corrosion testing.

FIG. 3 shows the nickel XPS spectra of (a) Sample E and (b) Sample F.

FIG. 4 shows the tungsten XPS spectra of (a) Sample E (b) Sample F.

FIG. 5 shows the oxygen XPS spectra of (a) Sample E (b) Sample F.

FIG. 6 shows an example of a waveform comprising a reverse pulse sequence, according to one embodiment of the invention.

FIG. 7 shows an example of a waveform comprising (i) a segment including a single, forward pulse and (ii) a segment including a reverse pulse sequence, according to one embodiment of the invention.

### DETAILED DESCRIPTION

The present invention generally relates to coated articles and related methods. The coatings may provide advantageous properties, such as high strength, hardness, brightness, abrasion resistance, corrosion resistance, reduced macroscopic defects (e.g., cracks, voids). In some cases, the coatings are comprised of an alloy, such as a nickel-tungsten alloy. Some embodiments of the invention advantageously provide the ability to tailor various coating features, such as chemical composition, grain size, and the like. For example, the coatings may include portions having different chemical compositions that impart different properties. For instance, the coating may include a top portion that enhances corrosion resistance formed on a lower portion that has a high strength. As described further below, the coating, or portions thereof, may be formed via an electrodeposition process which can involve coating an article in an electrodeposition bath that contains suitable species.

The coated articles may include a substrate and a coating formed on the substrate. In some cases, the coating may be formed on at least a portion of the substrate surface. In other cases, the coating covers the entire substrate surface.

The coating comprises one or more metal. For example, the coating may comprise an alloy (e.g., a nickel-tungsten alloy). Examples of suitable alloys may include two or more of the following elements: Ni, W, Fe, B, S, Co, Mo, Cu, Cr, Zn and Sn, amongst others. In some cases, alloys that comprises tungsten (e.g., nickel-tungsten alloys) are particularly preferred. Some specific examples of alloys include Ni—W, Ni—Fe—W, Ni—B—W, Ni—S—W, Co—W, Ni—Mo, Co—Mo and Ni—Co—W.

In some embodiments, it may be advantageous for the coating to be substantially free of elements or compounds having a high toxicity or other disadvantages. In some embodiments, it may be advantageous for the coating to be substantially free of elements or compounds that are deposited using species that have a high toxicity or other disadvantages. For example, in some cases, the coating may be free of chromium (e.g., chromium oxide) since it is often deposited using chromium ionic species (e.g., Cr⁶⁺) which are toxic. Such coatings may provide various processing, health, and environmental advantages over previous coatings.

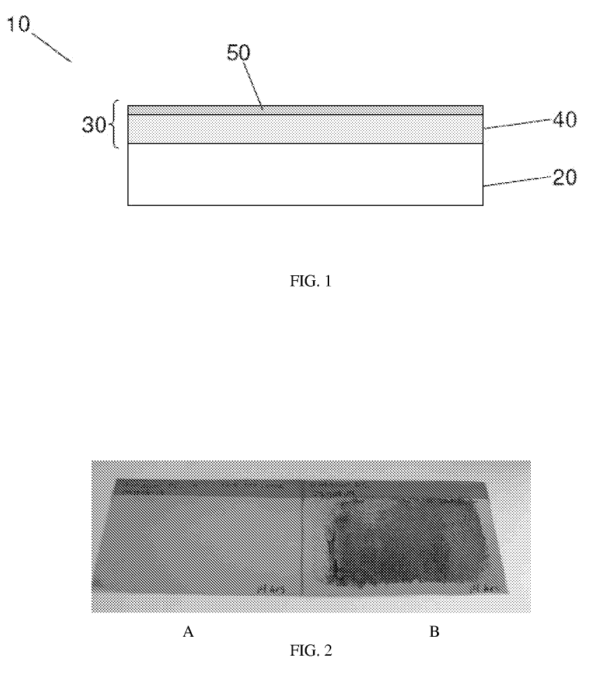

Some embodiments may include coatings having one or more portions, wherein each portion may exhibit a different characteristic and/or property, including chemical composition, thickness, microstructure (e.g., crystallinity, grain size), corrosion resistance, and the like. For example, the coating may have a first portion and a second portion, wherein the first portion is on an underlying substrate and the second portion is on the first portion. The second portion may also be referred to as a top portion. For example, as shown in FIG. 1, article 10 includes substrate 20 on which a coating 30 is formed. The coating includes a first portion 40 in contact with the substrate and a second portion 50 formed on the first portion.

It should be understood that, in other embodiments, the coating may comprise more than two portions having different characteristics and/or properties. Also, in some embodiments, the coating may only comprise a single portion having the same general characteristics and properties.

In some cases, the first portion of the coating comprises more than one metal such as nickel and tungsten. For example, the first portion may be a nickel and tungsten alloy. In some cases, the first portion includes nickel and tungsten, wherein the weight percentage of nickel in the first portion is at least 30 percent, at least 40 percent, at least 50 percent, at least 60 percent, or greater. In an illustrative embodiment, the first portion may include about 60 weight percent nickel and about 40 weight percent tungsten. In some embodiments, the first portion may be substantially free of oxygen, i.e., the weight percentage of oxygen in the first portion is less than 1 percent.

The coating may further comprise a second portion formed on the first portion. For example, the second portion may include oxygen and one or more metals. In some cases, the second portion includes nickel, tungsten, and oxygen. Some embodiments may advantageously include low amounts of tungsten. For example, when the second portion includes nickel, tungsten and oxygen, the weight percentage of tungsten in the second portion may be less than the weight percentage of nickel in the second portion. In some cases (e.g., when the second portion comprises nickel, tungsten and oxygen), the weight percentage of tungsten in the second portion is between 1 and 20 percent; in some cases, the weight percentage is between 5 and 15 percent (e.g., about 10 percent). The second portion may include relatively high amounts nickel. For example, when the second portion comprises nickel, tungsten and oxygen, the second portion may include at least 50 weight percent nickel; and, in some cases, at least about 70 weight percent nickel; or, in some cases, at least 80 weight percent nickel. In some embodiments, the ratio of the weight percent nickel to weight percent tungsten is greater than 15:1, or greater than 20:1. As described further below, the composition of the second portion can enhance corrosion resistance.

The second portion may include one or more metal oxide species. The metal oxide species may include, for example, nickel oxides, tungsten oxides, nickel-tungsten oxides, and the like. The composition of the coatings, or portions thereof, may be characterized using suitable techniques known in the art, such as Auger electron spectroscopy (AES). For example, AES may be used to characterize the chemical composition of the surface of the coating.

Various portions of the coating may be arranged in any configuration suitable for use in a particular application. In some cases, the second portion may be arranged as a top portion of the coating. That is, the surface of the second portion may define the surface of the article and no further portions of the coating may be present on the second portion. For example, the second portion may be positioned as a top portion of a coating in order to provide corrosion resistance properties. In some embodiments, the second portion may be positioned within an interior portion or layer of the coating. In some cases, the coating may comprise multiple portions comprising nickel, tungsten, and oxygen, wherein the portions may be positioned as the top portion of the coating and/or positioned within the interior of the coating. In one embodiment, the coating may have a layered structure comprising alternating layers of first portions and second portions.

As noted above, coatings described herein may comprise one or more metals. Those of ordinary skill in the art would be able to select appropriate metals or combinations of metals that would impart the desired characteristics or properties to an article, including corrosion resistance.

The coating, and portions thereof, may have any thickness suitable for a particular application. For example, the total coating thickness may be between 10 nm and 1 mm; in some cases, between 100 nm and 200 micron; and, in some cases, between 100 nm and 100 micron. In some embodiments, when the coating comprises a first portion and a second portion formed on the first portion, the first portion may be thicker than the second portion. For example, the first portion may have a thickness greater than 2 times, greater than 5 times, or greater than 10 times the thickness of the second portion. The second portion, for example, may be between 1 nm and 500 nm, or, 10 nm and 500 nm, or 50 nm and 250 nm.

It should be understood, however, that the coating, and portions thereof, may also have other thicknesses outside the above-noted ranges.

In some cases, the coatings may have a particular microstructure. For example, at least a portion of the coating may have a nanocrystalline microstructure. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. In some embodiments, at least a portion of the coating may have an amorphous structure. As known in the art, an amorphous structure is a non-crystalline structure characterized by having no long range symmetry in the atomic positions. Examples of amorphous structures include glass, or glass-like structures. Some embodiments may provide coatings having a nanocrystalline structure throughout essentially the entire coating. Some embodiments may provide coatings having an amorphous structure throughout essentially the entire coating.

In some embodiments, the coating may comprise various portions having different microstructures. The coating may include, for example, one or more portions having a nanocrystalline structure and one or more portions having an amorphous structure. In one set of embodiments, the coating comprises nanocrystalline grains and other portions which exhibit an amorphous structure. In some cases, the coating, or portion thereof, may comprise a portion having crystal grains, a majority of which have a grain size greater than one micron in diameter. In some embodiments, the coating may include other structures or phases, alone or in combination with a nanocrystalline portion or an amorphous portion. For example, particulates of metal, ceramic, intermetallic, solid lubricant particles of graphite or MoS₂, or other materials may be incorporated into coatings having a nanocrystalline portion or an amorphous portion. Those of ordinary skill in the art would be able to select other structures or phases suitable for use in the context of the invention.

Various substrates may be coated to form coated articles, as described herein. In some cases, the substrate may comprise an electrically conductive material, such as a metal, metal alloy, intermetallic material, or the like. Suitable substrates include steel, copper, aluminum, brass, bronze, nickel, polymers with conductive surfaces and/or surface treatments, transparent conductive oxides, amongst others.

In some embodiments, the invention provides coated articles that are capable of resisting corrosion, and/or protecting an underlying substrate material from corrosion, in one or more potential corrosive environments. Examples of such corrosive environments include, but are not limited to, aqueous solutions, acid solutions, alkaline or basic solutions, or combinations thereof. For example, coated articles described herein may be resistant to corrosion upon exposure to (e.g., contact with, immersion within, etc.) a corrosive environment, such as a corrosive liquid, vapor, or humid environment. In some cases, metal coatings (e.g., Ni—W alloy coatings) described herein may be resistant to corrosion upon exposure to, for example, neutral saline solution (NSS) spray, other salt sprays or salt fogs, solutions comprising acetic acids, solutions comprising copper sulfate or other salts, solutions containing citric acid or other acids, solutions containing alkaline or basic components, and the like.

Coated articles described herein may exhibit excellent corrosion resistance significantly higher than other conventional coated articles. For example, the corrosion resistance may be assessed using copper acetic acid salt spray (CASS) testing, a common corrosion test which provides an environment that can cause corrosion, discoloration, tarnishing, and degradation of coatings. CASS corrosion testing is carried out following the specifications laid out in ASTM standard B368, entitled “Standard Test Method for Copper-Accelerated Acetic Acid-Salt Spray (Fog) Testing (CASS Test)”. This test outlines a procedure in which coated substrate samples are introduced into a corrosion cabinet under specific standard conditions, and exposed to a corrosive atmosphere. The exposure time can be variable, and is generally specified by the end user of the product or coating being tested. After a prescribed amount of exposure time, the panel is examined visually by human eye for signs of change to the surface appearance resulting from tarnishing and/or discoloration and/or corrosion. Depending upon the coating and substrate involved in the test, there may be any or all of these effects. For example, steel surfaces may exhibit red rust after exposure to the corrosion atmosphere. Many lustrous coatings are tested to assess their tendency to tarnish or discolor. Usually, the change in surface appearance as a result of corrosion and/or tarnish and/or discoloration of the coating will be non-uniform, with some portions changed and other portions unchanged. Thus, only some fraction of the exposed surface area is considered corroded and/or tarnished and/or discolored, and this area fraction is a quantifiable measure of corrosion. The lower the area fraction, the more corrosion or tarnish resistant the coating or product is said to be.

CASS corrosion test results can be reported using a simple pass/fail approach. In this approach, a critical surface area fraction is specified, along with a specified time. If, after CASS testing for the specified time, the fraction of the surface area of the coating that changes in appearance resulting from tarnishing and/or discoloration and/or corrosion is below the specified critical value, the result is considered passing. If more than the critical fraction of surface area has changed in appearance resulting from tarnishing and/or discoloration and/or corrosion, then the result is considered failing.

As used herein, the “CASS corrosion lifetime” is the time until 1% of the exposed coating surface area exhibits a visual change in appearance resulting from corrosion and/or tarnish and/or discoloration as recognizable to one of ordinary skill in the art. In some cases, coated articles of the invention may exhibit a CASS corrosion lifetime of more than 2 hours, more than 5 hours, or more than 10 hours of resistance. In some cases, the coated articles may exhibit even greater CASS corrosion lifetimes. For example, some coated articles may exhibit CASS corrosion lifetimes of more than 50 hours, more than 75 hours, or more than 96 hours. In an illustrative embodiment, a Ni—W-alloy coating comprising a portion comprising Ni, W, and oxygen may have a CASS corrosion lifetime of greater than 2 hours, and, oftentimes, much greater including the lifetimes described above. Without wishing to be bound by theory, incorporation of a top portion as described above (e.g., metal oxides) within the coating may enhance the corrosion resistance properties of the coated article.

Some embodiments of the invention involve methods for electrodepositing a coating (e.g., electroplate). Electrodeposition generally involves the deposition of a material (e.g., electroplate) on a substrate by contacting the substrate with a electrodeposition bath and flowing electrical current between two electrodes through the electrodeposition bath, i.e., due to a difference in electrical potential between the two electrodes. For example, methods described herein may involve providing an anode, a cathode, an electrodeposition bath (also known as an electrodeposition fluid) associated with (e.g., in contact with) the anode and cathode, and a power supply connected to the anode and cathode. In some cases, the power supply may be driven to generate a waveform for producing a coating, as described more fully below. In some embodiments, at least one electrode may serve as the substrate to be coated.

The electrodeposition may be modulated by varying the potential that is applied between the electrodes (e.g., potential control or voltage control), or by varying the current or current density that is allowed to flow (e.g., current or current density control). In some embodiments, the coating may be formed (e.g., electrodeposited) using direct current (DC) plating, pulsed current plating, reverse pulse current plating, or combinations thereof. Pulses, oscillations, and/or other variations in voltage, potential, current, and/or current density, may also be incorporated during the electrodeposition process, as described more fully below. For example, pulses of controlled voltage may be alternated with pulses of controlled current or current density. In general, during an electrodeposition process an electrical potential may exist on the substrate to be coated, and changes in applied voltage, current, or current density may result in changes to the electrical potential on the substrate. In some cases, the electrodeposition process may include the use waveforms comprising one or more segments, wherein each segment involves a particular set of electrodeposition conditions (e.g., current density, current duration, electrodeposition bath temperature, etc.), as described more fully below.

Some embodiments of the invention involve electrodeposition methods wherein the grain size of electrodeposited materials (e.g., metals, alloys, and the like) may be controlled. In some embodiments, selection of a particular coating (e.g., electroplate) composition, such as the composition of an alloy deposit, may provide a coating having a desired grain size. For example, in electroplated alloys of Ni—W, Ni—P, and the like, the incorporation of relatively high amounts of W or P may produce coatings having relatively fine, nanocrystalline grain sizes, or, in some cases, amorphous structures. In some embodiments, electrodeposition methods (e.g., electrodeposition conditions) described herein may be selected to produce a particular composition, thereby controlling the grain size of the deposited material. The methods of the invention may utilize certain aspects of methods described in U.S. Patent Publication No. 2006/02722949, entitled “Method for Producing Alloy Deposits and Controlling the Nanostructure Thereof using Negative Current Pulsing Electro-deposition, and Articles Incorporating Such Deposits,” which is incorporated herein by reference in its entirety. Aspects of other electrodeposition methods may also be suitable including those described in U.S. Patent Publication No. 2006/0154084 and U.S. application Ser. No. 11/985,569, entitled “Methods for Tailoring the Surface Topography of a Nanocrystalline or Amorphous Metal or Alloy and Articles Formed by Such Methods”, filed Nov. 15, 2007, which are incorporated herein by reference in their entireties.

In some embodiments, a coating, or portion thereof, may be electrodeposited using direct current (DC) plating. For example, a substrate (e.g., electrode) may be positioned in contact with (e.g., immersed within) a electrodeposition bath comprising one or more species to be deposited on the substrate. A constant, steady electrical current may be passed through the electrodeposition bath to produce a coating, or portion thereof, on the substrate.

In some cases, the electrodeposition method involves driving a power supply to generate a waveform to electrodeposit a coating. The waveform may have any shape, including square waveforms, non-square waveforms of arbitrary shape, and the like. As described further below, in some methods such as when forming coatings having different portions, the waveform may have different segments used to form the different portions. However, it should be understood that not all methods use waveforms having different segments.

In some cases, a bipolar waveform may be used, comprising at least one forward pulse and at least one reverse pulse, i.e., a “reverse pulse sequence.” In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of composition and/or grain size of the coating that is produced.

In some embodiments, a reverse pulse sequence may be applied such that the forward (e.g., positive) current density, when integrated over the duration of the forward current pulse(s), is of a similar magnitude to the reverse (e.g., negative) current density integrated over the duration of the reverse current segment. FIG. 6 shows an example of a reverse pulse sequence, wherein portions A represent the reverse current density integrated over the duration of the reverse current pulse(s) and portions B represent the forward current density integrated over the duration of the forward current pulse(s). In some cases, the ratio of the sum of the average forward current density integrated over the duration of the forward pulse(s) (e.g., portions B) to the sum of the average reverse pulse integrated over the duration of the reverse pulse (portions A) is between 0.5 and 5, between 1 and 5, or, in some cases, between 1 and 2.

In one set of embodiments, at least one forward pulse has a duration between about 1 and about 100 ms, with an average forward current density of between about 0.01 and 1 A/cm², and at least one reverse pulse has a duration between about 1 and about 100 ms, with an average reverse current density of between about 0.01 and 1 A/cm².

Some embodiments involve the use of reverse pulse sequences to produce coating compositions having certain properties, such as corrosion resistance. One set of embodiments involves the use of a waveform including a first pulse of forward current density at 0.09 A/cm² for 12 ms, followed by a second pulse of reverse current density at 0.075 A/cm² for 8 ms, to produce coatings as described herein.

In some cases, the product of the forward current density and the duration of the forward current is about 1.08 A·ms/cm², while the product of the reverse current density and the duration of the reverse current is about 0.6 A·ms/cm². These two values are of similar magnitude, with the ratio of the forward and reverse values being about 1.8. Other ratios may be used as well, including ratios in the range of about 0.5 to about 5.

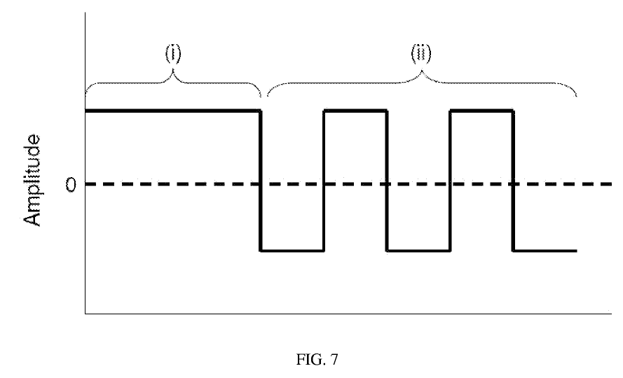

As noted above, some embodiments may include a waveform having more than one segment, each segment including a particular set of electrodeposition conditions. That is, the waveform is different in different segments. For example, the waveform may include one segment comprising at least one forward pulse and at least one reverse pulse (e.g., a bipolar waveform or a reverse pulse sequence), and another segment comprising a single forward, or reverse, pulse. In some cases, the segment having the single pulse may be arranged prior to the segment having the reverse pulse sequence. For example, FIG. 7 shows an example of a waveform comprising (i) a first segment including a single, forward pulse and (ii) a second segment including a reverse pulse sequence, according to one embodiment of the invention. In some cases, the second segment is similar to the waveform shown in FIG. 6. It also should be understood that the waveform may have more segments in addition to the first and second segments.

In some methods, with reference to FIG. 1, first portion 40 of the coating may be formed using the first segment of the waveform and second portion 50 of the coating may be formed using the second portion waveform. The parameters (e.g., pulse type, duration, etc.) of the first and second segments may be selected so as to impart desirable characteristics (e.g., composition, grain size) in the corresponding coating portions formed during those segments. In some cases, the second (e.g., upper) portion may comprise nickel, tungsten and oxygen, wherein the weight percentage of tungsten in the upper portion is between 1 and 20 percent. Methods using waveforms as described herein may provide the ability to produce a wide range of coatings within a relatively quick amount of time and without the need to change either the composition or temperature of the electrodeposition bath.

In some cases, the second segment used to form the second (e.g., top) portion may be a reverse pulse sequence applied for a duration of a few seconds to many minutes. In some cases, the second segment (e.g., reverse pulse sequence) is applied for at least 1 second, at least 5 seconds, at least 10 seconds, or, in some cases, at least 20 seconds, to produce a top portion having the desired surface and corrosion resistance properties. In some cases, the second segment (e.g., reverse pulse segment) is applied for a duration of at least one minute, or greater. In some cases, the second segment (e.g., reverse pulse sequence) is applied for less than 5 minutes, or less than 3 minutes, or less than 2 minutes, or less than 1 minute. The time duration of the second segment may be shorter than the time duration of the first segment. It should be understood that the duration of the second segment (e.g., reverse pulse segment) may be varied to produce a desired coating.

In general, the time duration for the first segment is not limited. For example, the first segment may be between 1 minute and 10 hours; though, it should be understood that other time durations are also possible.

In some cases, the invention provides methods for producing coatings having a particular microstructure. For example, coatings comprising a nanocrystalline portion may be produced by various electrodeposition techniques, including the addition of grain refining additives, deposition of an alloy that takes an at least nanocrystalline form, use of pulsed current, or use of reverse pulsed current. Other methods for modulating the microstructure of the coating are described in U.S. Patent Publication No. 2006/02722949.

As described herein, some embodiments of the invention involve the use of an electrodeposition bath. Electrodeposition baths typically include species that may be deposited on a substrate (e.g., electrode) upon application of a current. For example, an electrodeposition bath comprising one or more metal species (e.g., metals, salts, other metal sources) may be used in the electrodeposition of a coating comprising a metal (e.g., an alloy). In some cases, the electrochemical bath comprises nickel species (e.g., nickel sulfate) and tungsten species (e.g., sodium tungstate) and may be useful in the formation of, for example, nickel-tungsten alloy coatings.

Typically, the electrodeposition baths comprise an aqueous fluid carrier (e.g., water). However, it should be understood that other fluid carriers may be used in the context of the invention, including, but not limited to, molten salts, cryogenic solvents, alcohol baths, and the like. Those of ordinary skill in the art would be able to select suitable fluid carriers for use in electrodeposition baths. In some cases, the electrodeposition bath may be selected to have a pH from about 7.0-9.0. In some cases, the electrodeposition bath may have a pH from about 7.6 to 8.4, or, in some cases, from about 7.9 to 8.1.

The electrodeposition baths may include other additives, such as wetting agents, brightening or leveling agents, and the like. Those of ordinary skill in the art would be able to select appropriate additives for use in a particular application. In some cases, the electrodeposition bath includes citrate ions as additives. In some cases, the citrate ion content may be from about 35-150 g/L, 40-80 g/L, or, in some cases, 60-66 g/L.

Methods of the invention may be advantageous in that coatings (e.g., Ni—W alloy coatings) having various compositions may be readily produced by a single electrodeposition step. For example, a coating comprising a layered composition, graded composition, etc., may be produced in a single electrodeposition bath and in a single deposition step by selecting a waveform having the appropriate segments. The coated articles produce may exhibit enhanced corrosion resistance and surface properties.

It should be understood that other techniques may be used to produce coatings as described herein, including vapor-phase processes, sputtering, physical vapor deposition, chemical vapor deposition, thermal oxidation, ion implantation, etc.

The following examples should not be considered to be limiting but illustrative of certain features of the invention.

### EXAMPLES

### Example 1

In the following example, articles coated with Ni—W alloys were produced by aqueous electrodeposition. The article to be coated was immersed in a solution, and a current was applied for electrodeposition. The components of the solution used for deposition are listed in Table I, along with some of the conditions used in the electrodeposition process. The pH of the solution was balanced to a value of 8.0 using ammonium hydroxide. Reverse pulsed current was applied with the characteristics shown in Table I. The reverse pulse scheme used here is similar to that taught by U.S. Patent Publication No. 2006/02722949. Several coatings were prepared atop brass substrates, using a counter electrode of stainless steel.

TABLE 1
Deposition conditions for experiments one and two.

| Citrate ions | 63 g/L |
|---|---|
| Nickel (from nickel sulfate) | 6.5 g/L |
| Tungsten (from sodium tungstate) | 32.5 g/L |
| Forward current pulse time (ms) | 16 |
| Negative current pulse time (ms) | 4 |
| Positive current density (A/cm²) | 0.1 |
| Negative current density (A/cm²) | 0.02 |
| Bath temperature (° C.) | 60 |

A first coated article, Sample A, including a W—Ni alloy coating was prepared using the reverse-pulsing scheme detailed in Table 1. The coating was deposited for 20 minutes, and attained a thickness of approximately 10-12 micrometers, as measured by x-ray fluorescence (XRF). The XRF measurement also provided the composition of this coating, which was ˜40wt % W, remainder Ni. The coating in the as-deposited condition was bright and lustrous. According to line-broadening measurements using X-ray diffractometry, the grain size of this specimen was about 10±5 nm; the specimen was nanocrystalline. Thus, the coating prepared on Sample A in this experiment is produced using prior art methods as described in U.S. Patent Publication No. 2006/02722949.

Sample A was subjected to a corrosion test in a copper assisted acetic acid salt spray (CASS) chamber (see ASTM standard B368). After less than 2 hours in the CASS test, this coating exhibited discoloration from corrosive attack. The CASS corrosion lifetime was significantly less than 1 hour. After 4 hours, the corrosion was severe and the coating was no longer bright or lustrous.

A second coated article, Sample B, was prepared using the method described above, with approximately the same thickness as that cited above for Sample A. In this example, a first stage of W—Ni alloy deposition was carried out using the same conditions as in Sample A. At the conclusion of this first electroplating stage, an additional deposition stage was introduced in which the current waveform involved 12 ms of forward current, followed by 8 ms of reverse current. The current densities applied in this stage were 0.09 A/cm² forward, and 0.075 A/cm² reverse. This waveform was applied for one minute and yielded a second portion (i.e., a top portion) of the electrodeposited coating. This two-stage process was carried out in a single processing step, i.e., the specimen was immersed in the same electrodeposition bath for both stages of electrodeposition, which were performed in series. There was a change in the applied current waveform between stages, but only a single electrodeposition processing step was practiced here.

The coating produced in Sample B was comparable in thickness and composition according to the XRF measurement (˜40wt % W, balance Ni) to the coating in Sample A. The coating of Sample B in the as-deposited condition was bright and lustrous and, according to line-broadening measurements using X-ray diffractometry, the grain size of this specimen was about 10±5 nm; and the specimen was nanocrystalline.

Sample B was subjected to the essentially the same standard copper assisted acetic acid salt spray corrosion test as in Sample A. After 4 hours, no discernible corrosion was observed on the coating surface. Improved corrosion performance up to 96 hours was achieved. The CASS corrosion lifetime was at least 4 hours and likely significantly longer. It is interesting to note that the coatings in Sample A and Sample B appear similar when observed using bulk measurements like XRF or X-ray diffraction. That is, the coatings of Sample A and Sample B have about the same thickness, composition, and grain size. However, the corrosive and surface properties of Sample A and Sample B are clearly different. The results for Sample A are typical of Ni—W electrodeposits produced using previous methods, such as DC, pulse plating, or even reverse pulse plating strategies described previously. Such coatings are susceptible to CASS corrosion after only a short exposure time. By contrast, Sample B exhibited high resistance to CASS corrosion, indicating that coatings comprising a top portion may provide improved corrosion resistance to an article.

Additionally, Sample B was produced without requiring a secondary step, such as a passivation step, and without a CrO₃-containing solution that would leave a W-alloy coating containing some trace of Cr, or chromium oxides in the coating or on the coating surface.

### Example 2

Various properties of the samples produced in Example 1 were then studied to determine the effect of the character and composition of the outermost surface of the coatings on the corrosion properties of the sample. The compositions of the two specimens, Sample A and Sample B, were measured using Auger electron spectroscopy, prior to exposure to a corrosive environment. The Auger electron spectroscopy results indicated that the near surface regions of the two coatings were different.

Sample A had a surface composition comprising Ni (˜62 at %), W (˜22 at %) and O (˜16 at %). When the oxygen was excluded from the analysis, the ratio of the metals is about 75 at % Ni:25 at % W, or, expressed in weight percentages, 49 wt % Ni:51 wt % W. This composition was reasonably close to the bulk measurement provided by the XRF results, with a slight difference likely due to the presence of oxide on the surface. Sample B had a very different surface composition, comprising Ni (˜86 at %), W (˜4 at %) and O (˜10 at %). When oxygen is excluded from the analysis, the ratio of the metals is about 96:4 (Ni:W) as an atomic ratio, or about 88:12 (Ni:W) as a weight ratio. By any of these Auger measurements, the top portion of the coating on Sample B was different from the top of the coating on Sample A.

Thus, the specific procedures used to obtain Sample B yielded coated article having a different surface chemistry than in Sample A. Notably, the top portion of the coating (e.g., a layer of an oxide, combination of oxides, or oxygen-bearing phases) produced in Sample B had a different composition than that produced in Sample A. The oxide layer on Sample A was roughly of global atomic composition Ni₆₂W₂₂O₁₆, while that of Sample B was about Ni₈₆W₄O₁₀. It was not clear from the measurements whether the oxide layer included a single complex oxide phase, or a composite or combination of multiple different metal oxides and/or phases, or alloy phases with dissolved oxygen.

The different surface chemistry obtained in Sample B was likely responsible for the improved surface properties we measured, including improved corrosion and tarnishing protection. Thus, in some cases, coatings comprising an oxide layer which comprises less than about 20 at % W, nickel, and oxygen, can provide improved corrosion resistance and other desirable surface properties relative to a higher W-content oxide produced by known methods.

On the standard CIE Lab Color Scale, Sample A had a color measurement denoted by: L=82.5; a=0.28; b=3.16, while sample B had a color measurement denoted by: L=83.4; a=0.41; and b=5.26. This is a further manifestation of different surface phases and/or properties between the two samples.

As a control experiment, the coatings produced in Sample A and Sample B were also compared to those of coatings that did not contain W, which were produced by other Ni-plating methods known in the industry. The Ni coatings (e.g., W-free coatings) were coated on the same substrates as in Samples A and B, and the Ni coatings were of similar thickness (˜10-12 microns) as in Samples A and B, but with nominally pure Ni coatings produced from, for example, a typical bright nickel electroplating solution or from a nickel sulfamate bath. CASS corrosion experiments were performed on the Ni coatings, and, in all cases, the surface and corrosion properties of the Ni coatings were less desirable than those of the Ni—W coatings in Samples A and B. Thus, the presence of at least some W in the coating may be desirable for enhanced properties and improved corrosion protection.

Without wishing to be bound by theory, the presence of W may result in the formation of a desirable complex oxide or oxygen-bearing phase that involves both nickel and tungsten, or a composite of several different oxide phases involving one or both of those metal species. For example, Sample B included about 4 at % W in the oxide. In some cases, incorporation of at least 1 at % W within a coating may achieve the desired effects. Additionally, it may be desirable, in some cases, to produce coatings which include a portion comprising oxides, wherein the oxides include about 1-20 at % W, as well as nickel and oxygen. Such coatings may exhibit improved surface properties, corrosion resistance, and resistance to tarnishing or discoloration. The coatings may further comprise regions of a W-alloy, wherein the regions may or may not be at least nanocrystalline. In some cases, these coatings may be substantially free of chromium or chromium oxides, and may be produced without requiring an additional processing step after electroplating.

### Example 3

A variety of additional coating samples were produced and their properties studied. For example, Sample C and Sample D were produced using the methods described in Example 1 to produce Samples A and B, respectively, except that organic additives (i.e., leveling agents, wetting agents, brightening agents) were added to the electrodeposition bath in the amount of less than 1 g/L. Those of ordinary skill in the art would recognize that levelers, brighteners, ductility agents, wetters and the like may be commonly used in such small quantities in electrodeposition baths, and that many combinations of these may be present in different baths. In this Example, the presence of small concentrations of organic additive did not change the major results reported above for the Samples A and B. Sample C exhibited CASS corrosion in only a few hours, with quite substantial corrosion after 4 hours. Sample D, however, comprised the corrosion resistant top portion and had a CASS corrosion lifetime of at least 4 hours.

### Example 4

In the following example, conventional DC plating methods were used to produce Ni—W coatings. Sample E and Sample F were produced using the methods described in Example 1 to produce Samples A and B, respectively, except that layers were first deposited with a direct current (DC) condition at a constant applied current density of 0.09 A/cm². Both Sample E and Sample F included Ni—W coatings of about 20 microns thickness. After DC plating to form the Ni—W coating, Sample E was removed from the bath. By contrast, after DC plating to form the Ni—W coating, an additional top portion was formed on Sample F using the same DC current and the procedure used in Sample B (e.g., plating with 12 ms of 0.09 A/cm² forward current density, followed by 8 ms of 0.075 A/cm² reverse current density, with the forward/reverse sequence applied for one minute).

Sample E and Sample F exhibited all the same respective traits as those produced in Samples A and B. FIG. 2 shows a copy of a photograph after 14 hours of standard CASS corrosion testing, of panel specimens coated with Ni—W alloys using (a) a standard DC electrodeposition process (e.g., Sample E); and (b) a two-step, reverse-pulse electrodeposition process (e.g., Sample F). Whereas Sample E, produced using conventional DC plating, corroded to essentially complete discoloration in only 14 hours (FIG. 2A), Sample F withstood the CASS environment with essentially no discoloration, and no apparent corrosion or tarnishing after the same exposure. Further experiments showed that samples produced using the same conditions as in Sample F were capable of withstanding CASS corrosion conditions with essentially no corrosion for 88 hours. Thus, the CASS corrosion lifetime was at least 88 hours for this sample.

Prior to corrosion testing, Samples E and F were further analyzed to assess their surface chemistry and the oxides on the surface, using X-ray Photoelectron Spectroscopy (XPS). XPS analysis of Sample E revealed that the surface comprised nickel, tungsten, and oxygen, i.e., an oxide layer (or oxygen-bearing phase) containing nickel and tungsten. Furthermore, quantitative measurement of the metals content was possible, revealing the surface of Sample E had a Ni:W weight ratio of about 49 wt % : 51 wt %, which resembled the ratio measured by Auger spectroscopy (49:51) for Sample A. Both Sample A and Sample E were prepared using previous methods. XPS analysis of Sample F also revealed a surface oxygen-bearing layer containing Ni and W, but with a different metals ratio at the surface, namely 81 wt %: 19 wt %, for the Ni:W ratio. This ratio resembled the ratio measured by Auger spectroscopy for Sample B (e.g., 88:12). Both Sample B and Sample F were prepared with a final plating stage using a reverse pulse scheme which provided the top portion.

Thus, the XPS measurements for Samples E and F corroborated the above findings for Samples A and B using Auger spectroscopy, verifying that the top portion produced in Samples B and F had a different surface composition comprising less tungsten than in Samples A and B. The substantially improved CASS corrosion properties of Samples B and F, when compared to that of Samples A and E, indicate that the character of the surface phase or phases may affect corrosion behavior and other surface properties.

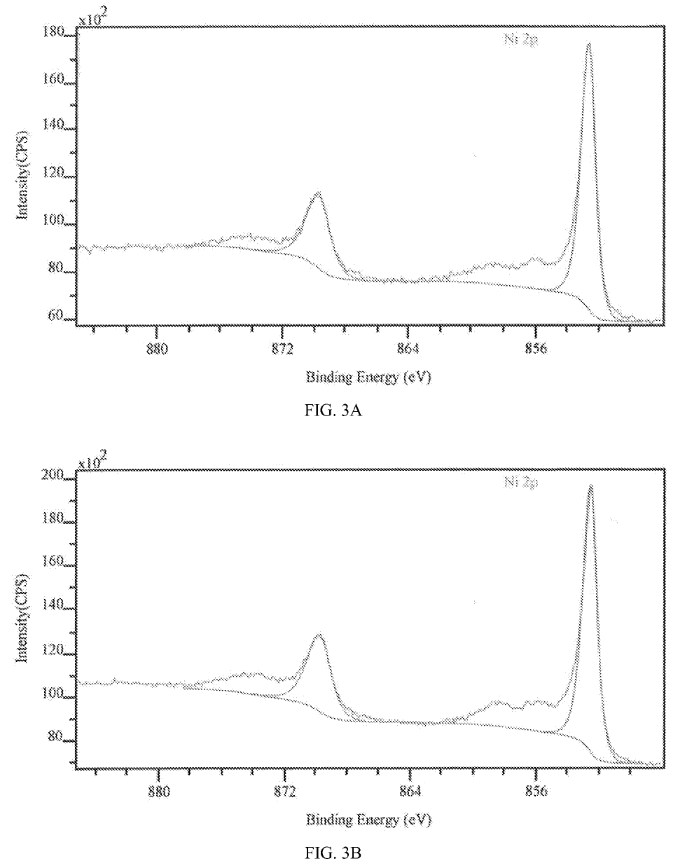

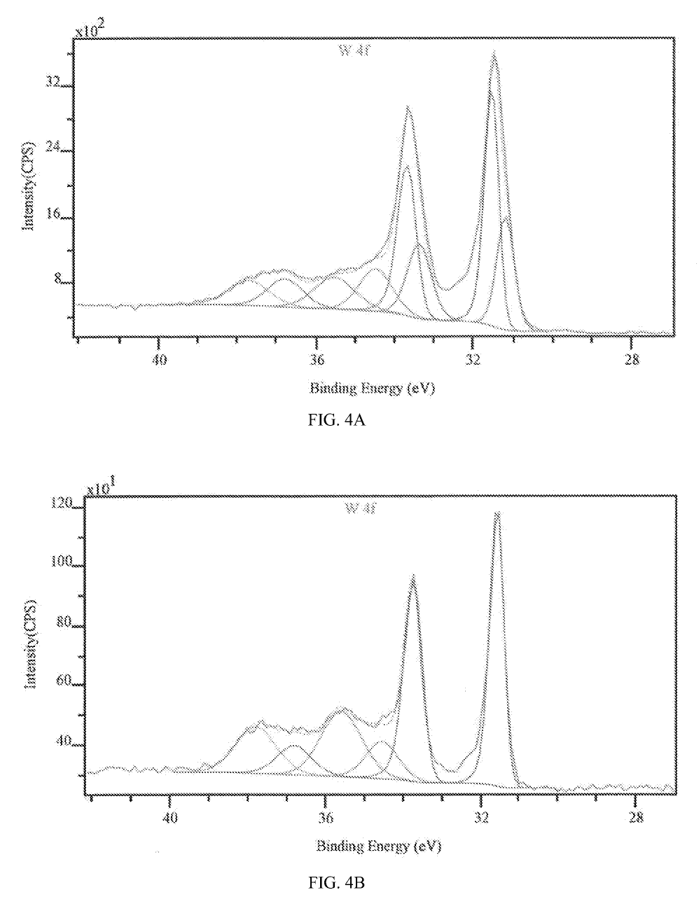

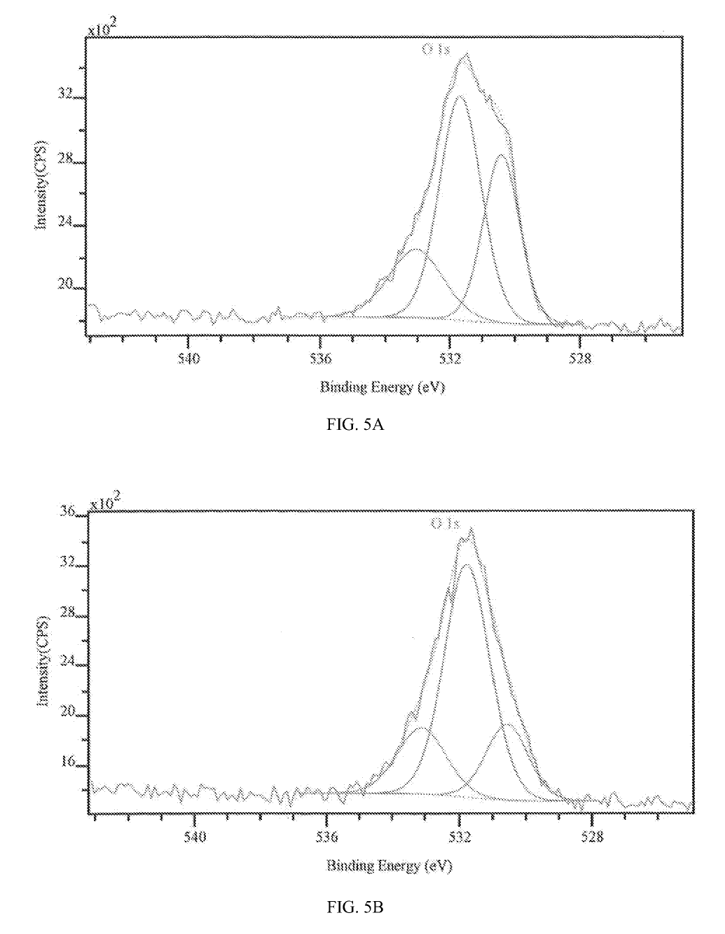

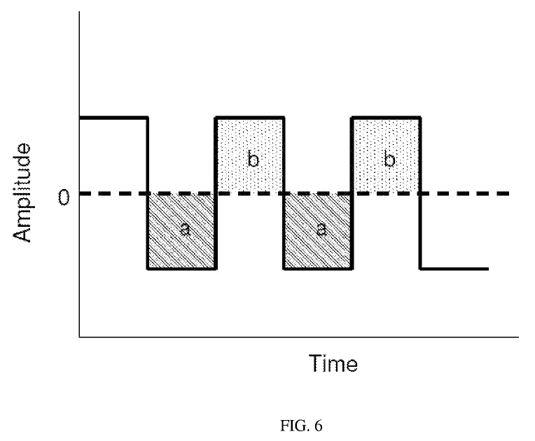

XPS analysis of Samples E and F also revealed clear evidence of the presence of oxygen within the coatings, as well as the presence of metal-oxygen bonds. FIG. 3 shows the nickel XPS spectra of (a) Sample E and (b) Sample F. As shown in FIG. 3, the nickel XPS spectra for specimens from Sample E (FIG. 3A) and Sample F (FIG. 3B) are similar, with two major peaks arising from the bonding of Ni in the metallic state. There are also secondary, smaller peaks, two of which are related to metallic Ni. A third peak, located at a binding energy of about 856 eV, is associated with metallic oxide involving nickel. FIG. 4 shows the tungsten XPS spectra of (a) Sample E (b) Sample F. In both spectra, the two large peaks can be associated with metallic tungsten bonding, and the smaller peaks can be associated with tungsten-containing oxides. Sample F exhibited more prominent oxide peaks relative to Sample E. The peaks to the left of these plots represent higher binding energies, i.e., atomic configurations that are more tightly bound. The data in FIG. 4 suggest that, in Sample F, atoms are, on average, more tightly bound than in Sample E. FIG. 5 shows the oxygen XPS spectra of (a) Sample E (b) Sample F. There is a very clear difference between the two spectra, with that in FIG. 5A showing a shoulder on the right side of the major peak, and that in FIG. 5B not showing this shoulder. The peaks to the left of these plots represent higher binding energies, i.e., atomic configurations that are more tightly bound. The data in FIG. 5 suggest that, in Sample F, atoms are, on average, more tightly bound than in Sample E.

Thus, the XPS studies indicate that there is a difference in the surface layer of Samples E and F, and that the oxides or oxygen-bearing phases atop these two samples are tangibly different. This correlates with composition measurements both by XPS and Auger spectroscopy, and with corrosion observations. Additional experiments have verified these results for a variety of substrates and other variations in the conditions. Other corrosive media, including copper-free acetic acid salt spray (according to ASTM G-85), and neutral salt sprays (NSS, according to ASTM B-117), have also been investigated. Experiments on substrates of brass and steel, of various different geometries, have been conducted. Immersion corrosion experiments in the various corrosive media have also been conducted. In each case, specimens with the characteristic top portion composition, or those produced using methods known to yield the characteristic top portion, showed improved corrosion resistance as compared with coatings produced using previous techniques.

What is claimed:

1. An article, comprising:
a substrate; and
a coating formed on the substrate, the coating having a first portion and a second portion, the second portion comprising nickel, tungsten and oxygen, wherein the weight percentage of tungsten in the second portion is between 1 and 20 percent.

2. The article of claim 1, wherein the second portion is formed on the first portion.

3. The article of claim 2, wherein the second portion is a top portion of the coating.

4. The article of claim 1, wherein the coating is substantially free of chromium or chromium oxide.

5. The article of claim 1, wherein the coating further comprises metal oxides.

6. The article of claim 1, wherein at least one of the first and second portions has a nanocrystalline structure.

7. The article of claim 1, wherein the first portion is substantially free of oxygen.

8. The article of claim 1, wherein the first portion comprises nickel and tungsten.

9. The article of claim 1, wherein the weight percentage of nickel in the second portion is at least 50 percent.

10. The article of claim 1, wherein the weight percentage of nickel in the second portion is at least 70 percent.

11. The article of claim 1, wherein the second portion of the coating has a thickness of between 10 nm and 500 nm.

12. The article of claim 1, wherein the first portion has a thickness greater than 5 times a thickness of the second portion.

13. The article of claim 1, further comprising a third portion.

14. The article of claim 1, wherein the second portion consists essentially of nickel, tungsten and oxygen.

15. An article, comprising:
a substrate;
a coating formed on the substrate, the coating comprising nickel and tungsten,
wherein the article has a CASS corrosion lifetime of at least 2 hours.

16. The article of claim 15, wherein the coating is substantially free of chromium or chromium oxide.

17. The article of claim 15, wherein the substrate comprises a metal.

18. The article of claim 15, wherein the coating has a first portion and a second portion formed on the first portion.

19. The article of claim 15, wherein the second portion comprises nickel, tungsten and oxygen, and the weight percentage of tungsten in the second portion is between 1 and 20 percent.

20. The article of claim 15, wherein the first portion comprises a nickel-tungsten alloy.

21. The article of claim 15, wherein the coating is electrodeposited.

22. The article of claim 15, wherein the coating has a nanocrystalline structure.

23. The article of claim 15, wherein the article has a CASS corrosion lifetime of at least 10 hours.
